(19) United States
(12) Patent Application Publication
(10) Pub. No.: US 2026/0110799 A1
(43) Pub. Date: Apr. 23, 2026

(54) IMPLICIT OCCUPANCY FOR AUTONOMOUS SYSTEMS

(71) Applicant: WAABI Innovation Inc., Toronto (CA)

(72) Inventors: Ben Taylor Caldwell AGRO, Toronto (CA); Quinlan SYKORA, Toronto (CA); Sergio CASAS ROMERO, Toronto (CA); Raquel URTASUN, Toronto (CA)

(73) Assignee: WAABI Innovation Inc., Toronto (CA)

(21) Appl. No.: 19/114,287

(22) PCT Filed: Nov. 10, 2023
(86) PCT No.: PCT/CA2023/051507

§ 371 Date: Mar. 21, 2025

Related U.S. Application Data
(60) Provisional application No. 63/424,864, filed on Nov. 11, 2022.

(51) Int. Cl. G01S 17/89; G05D 1/242; G05D 1/246; G05D 101/15; G06F 16/29; G06N 3/0455; G06N 3/0464

(52) U.S. Cl. CPC G01S 17/89; G05D 1/242; G05D 1/2464; G06F 16/29; G06N 3/0455; G06N 3/0464; G05D 2101/15

(57) ABSTRACT

Implicit occupancy for autonomous systems include receiving a request for a point attribute at a query point matching a geographic location, obtaining a query point feature vector from a feature map. The feature map encodes a geographic region that includes the geographic location. A first set of multilayer perceptrons of a decoder model process the query point feature vector to generate offsets. Offset feature vectors are obtained from the feature map for the offsets. A second set of multilayer perceptrons of the decoder model process the offset feature vectors and the query point feature vector to generate the point attribute. The operations further includes responding to the request with the point attribute.

### CROSS REFERENCE TO RELATED APPLICATIONS

This application is a non-provisional application of, and thereby claims benefit to, U.S. Patent Application Ser. No. 63/424,864 filed on Nov. 11, 2022. U.S. Patent Application Ser. No. 63/424,864 is incorporated herein by reference in its entirety.

### BACKGROUND

An autonomous system is a self-driving mode of transportation that does not require a human pilot or human driver to move in and react to the real-world environment. Rather, the autonomous system includes a virtual driver that is the decision making portion of the autonomous system. Specifically, the virtual driver controls the actuation of the autonomous system. The virtual driver is an artificial intelligence system that learns how to interact in the real world and then performs the interaction when in the real world.

Part of interacting in the real world is collision avoidance with other actors and objects in the environment. To more safely navigate the real-world environment autonomously, predictions have to be not only accurate and generalize across many scenarios, but also made in a timely manner so that the autonomous system can react appropriately.

Most autonomous systems are object-based. In an object based system, the objects of interest are first detected in the region. To do so, object detectors use threshold per-object confidence scores to determine which objects are in the scene, where the threshold is inherently a trade-off between precision and recall. Then, for each object, object-based motion forecasting methods are performed to predict only a handful of sample trajectories or parametric distributions for each object.

Recently, object-free approaches may be used. Object-free approaches do not detect individual objects. Rather, object free approaches predict occupancy probability and motion for each cell in a spatial-temporal grid, directly from sensor data. More specifically, the spatial-temporal grid is a three-dimensional dense grid with two spatial dimensions representing the bird's-eye view, and a temporal dimension from the current observation time to a future horizon of choice. All dimensions of the three dimensional grid are quantized at regular intervals. Thus, the object-free approach may be computationally expensive. However, no detection confidence thresholding is used and the distribution over future motion is much more expressive, enabling the downstream motion planner to plan with consideration of low-probability objects and futures.

### SUMMARY

In general, in one aspect, one or more embodiments relate to a method that includes receiving a request for a point attribute at a query point matching a geographic location, and obtaining a query point feature vector from a feature map. The feature map encodes a geographic region that includes the geographic location. A first set of multilayer perceptrons of a decoder model process the query point feature vector to generate offsets. Offset feature vectors are obtained from the feature map for the offsets. A second set of multilayer perceptrons of the decoder model process the offset feature vectors and the query point feature vector to generate the point attribute. The method further includes responding to the request with the point attribute.

In general, in one aspect, one or more embodiments relate to a system that includes a computer processor and a non-transitory computer readable medium for causing the computer processor to perform operations. The operations include receiving a request for a point attribute at a query point matching a geographic location, and obtaining a query point feature vector from a feature map. The feature map encodes a geographic region that includes the geographic location. A first set of multilayer perceptrons of a decoder model process the query point feature vector to generate offsets. Offset feature vectors are obtained from the feature map for the offsets. A second set of multilayer perceptrons of the decoder model process the offset feature vectors and the query point feature vector to generate the point attribute. The operations further include responding to the request with the point attribute.

In general, in one aspect, one or more embodiments relate to a non-transitory computer readable medium that include computer readable program code for causing a computer system to perform operations. The operations include receiving a request for a point attribute at a query point matching a geographic location, and obtaining a query point feature vector from a feature map. The feature map encodes a geographic region that includes the geographic location. A first set of multilayer perceptrons of a decoder model process the query point feature vector to generate offsets. Offset feature vectors are obtained from the feature map for the offsets. A second set of multilayer perceptrons of the decoder model process the offset feature vectors and the query point feature vector to generate the point attribute. The operations further include responding to the request with the point attribute.

Other aspects of the invention will be apparent from the following description and the appended claims.

### BRIEF DESCRIPTION OF DRAWINGS

FIG. 1 shows an autonomous system with a virtual driver in accordance with one or more embodiments.

FIG. 2 shows a simulation environment for training a virtual driver of an autonomous system in accordance with one or more embodiments of the invention.

FIG. 3 shows a diagram of components of a virtual driver in accordance with one or more embodiments of the invention.

FIG. 4 shows a diagram of a feature map in accordance with one or more embodiments of the invention.

FIG. 5 shows a diagram of components of a virtual driver with an exploded view of the encoder model in accordance with one or more embodiments of the invention.

FIG. 6 shows a diagram of components of a virtual driver with an exploded view of the implicit decoder model in accordance with one or more embodiments of the invention.

FIG. 7 shows a flowchart for implicit occupancy determination in accordance with one or more embodiments of the invention.

FIG. 8 shows an example diagram of explicit and implicit occupancy in accordance with one or more embodiments of the invention.

FIG. 9 shows an example implementation in accordance with one or more embodiments.

FIGS. 10A and 10B show a computing system in accordance with one or more embodiments of the invention.

Like elements in the various figures are denoted by like reference numerals for consistency.

### DETAILED DESCRIPTION

In general, embodiments are directed to implicit occupancy of a geographic region for autonomous systems. In particular, the geographic region includes the agents, physical objects, and various map elements. The agents are the actors in the geographic regions that are capable of independent decision making and movement while the physical objects may be stationary or transitory items that may or may not move. The map elements are physical portions of the geographic region that may be reflected in a map of the geographic region. Agents and physical objects may be located at various geographic locations in the geographic region. Whether an agent or a physical object is located at a geographic location is the occupancy of the geographic location. Namely, occupancy for a geographic location is a binary question of whether the geographic location will or will not be occupied at a particular point in time. The determination of occupancy is important for an autonomous system because if an autonomous system moves to an occupied geographic location, then a collision occurs.

Rather than identifying individual agents or objects and the corresponding trajectories, one or more embodiments predict whether a particular geographic location in the geographic region will be occupied without consideration of a particular agent or physical object performing the occupying. In determining whether an autonomous system is safe to move to a particular location, embodiments effectively combine the identification of agents and physical objects, corresponding trajectories, and whether the corresponding trajectories include the geographic location into a single prediction of whether the geographic location will be occupied.

Moreover, one or more embodiments perform the prediction on a per query point basis. The query point is used as an input to the various machine learning models that determine the implicit occupancy. In one or more embodiments, the occupancy for only a subset of geographic locations is determined rather than building an occupancy grid and performing a lookup in the occupancy grid. By not building an entire occupancy grid, computing resources may be saved. Further, whereas an occupancy grid has a fixed resolution, the query point is not limited to a fixed position and size in one or more embodiments.

In one or more embodiments, the performance of the implicit occupancy proceeds as follows. A feature map is obtained for the geographic region. The feature map has features about the current and past state of the geographic region regarding which geographic locations were occupied amongst other possible information (e.g., features about motion, intention such as area of lane-change, geometry, object type, etc.). A request for a point attribute at a query point is received. The query point is for a particular geographic location. The query point is used to obtain a query point feature vector from the feature map. The query point feature vector is passed through a first set of multilayer perceptrons of a decoder model to obtain a set of offsets corresponding to offset locations in the geographic region. Offset feature vectors for the offset locations are obtained from the feature map. The query point feature vector and the offset feature vector are processed by a second set of multilayer perceptrons of a decoder model to generate the point attribute. The point attribute is returned.

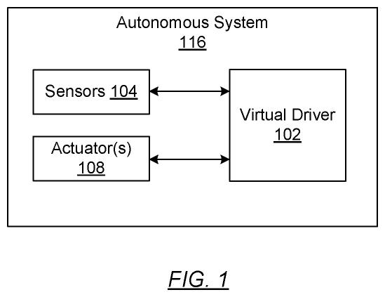

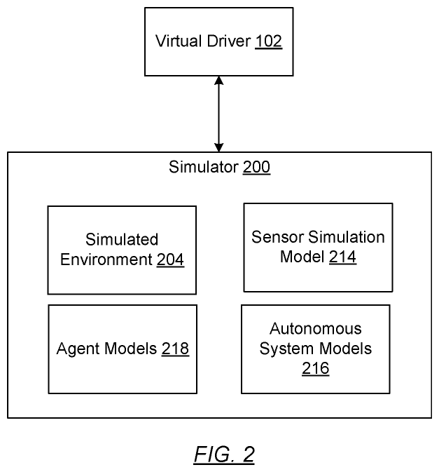

Turning to the Figures, FIGS. 1 and 2 show example diagrams of the autonomous system and virtual driver. Turning to FIG. 1, an autonomous system (116) is a self-driving mode of transportation that does not require a human pilot or human driver to move and react to the real-world environment. The autonomous system (116) may be completely autonomous or semi-autonomous. As a mode of transportation, the autonomous system (116) is contained in a housing configured to move through a real-world environment. Examples of autonomous systems include self-driving vehicles (e.g., self-driving trucks and cars), drones, airplanes, robots, etc.

The autonomous system (116) includes a virtual driver (102) that is the decision making portion of the autonomous system (116). The virtual driver (102) is an artificial intelligence system that learns how to interact in the real world and interacts accordingly. The virtual driver (102) is the software executing on a processor that makes decisions and causes the autonomous system (116) to interact with the real-world including moving, signaling, and stopping or maintaining a current state. Specifically, the virtual driver (102) is decision making software that executes on hardware (not shown). The hardware may include a hardware processor, memory or other storage device, and one or more interfaces. A hardware processor is any hardware processing unit that is configured to process computer readable program code and perform the operations set forth in the computer readable program code.

A real world environment is the portion of the real world through which the autonomous system (116), when trained, is designed to move. Thus, the real world environment may include concrete and land, construction, and other objects in a geographic region along with agents. The agents are the other agents in the real world environment that are capable of moving through the real world environment. Agents may have independent decision making functionality. The independent decision making functionality of the agent may dictate how the agent moves through the environment and may be based on visual or tactile cues from the real world environment. For example, agents may include other autonomous and non-autonomous transportation systems (e.g., other vehicles, bicyclists, robots), pedestrians, animals, etc.

In the real world, the geographic region is an actual region within the real-world that surrounds the autonomous system. Namely, from the perspective of the virtual driver, the geographic region is the region through which the autonomous system moves. The geographic region includes agents and map elements that are located in the real world. Namely, the agents and map elements each have a physical location in the geographic region that denotes a place in which the corresponding agent or map element is located. The map elements are stationary in the geographic region, whereas the agents may be stationary or nonstationary in the geographic region. The map elements are the elements shown in a map (e.g., road map, traffic map, etc.) or derived from a map of the geographic region.

The real world environment changes as the autonomous system (116) moves through the real world environment. For example, the geographic region may change and the agents may move positions, including new agents being added and existing agents leaving.

In order to interact with the real-world environment, the autonomous system (116) includes various types of sensors (104), such as LiDAR sensors amongst other types, which are used to obtain measurements of the real-world environment, and cameras that capture images from the real world environment. The autonomous system (116) may include other types of sensors as well. The sensors (104) provide input to the virtual driver (102).

In addition to sensors (104), the autonomous system (116) includes one or more actuators (108). An actuator is hardware and/or software that is configured to control one or more physical parts of the autonomous system based on a control signal from the virtual driver (102). In one or more embodiments, the control signal specifies an action for the autonomous system (e.g., turn on the blinker, apply breaks by a defined amount, apply accelerator by a defined amount, turn the steering wheel or tires by a defined amount, etc.). The actuator(s) (108) are configured to implement the action. In one or more embodiments, the control signal may specify a new state of the autonomous system and the actuator may be configured to implement the new state to cause the autonomous system to be in the new state. For example, the control signal may specify that the autonomous system should turn by a certain amount while accelerating at a predefined rate, while the actuator determines and causes the wheel movements and the amount of acceleration on the accelerator to achieve a certain amount of turn and acceleration rate.

The testing and training of the virtual driver (102) of the autonomous systems in the real-world environment is unsafe because of the accidents that an untrained virtual driver can cause. Thus, as shown in FIG. 2, a simulator (200) is configured to train and test a virtual driver (102) of an autonomous system. For example, the simulator may be a unified, modular, mixed-reality, closed-loop simulator for autonomous systems. The simulator (200) is a configurable simulation framework that enables not only evaluation of different autonomy components of the virtual driver (102) in isolation, but also as a complete system in a closed-loop manner. The simulator reconstructs “digital twins” of real world scenarios automatically, enabling accurate evaluation of the virtual driver at scale. The simulator (200) creates the simulated environment (204) which is a virtual world in which the virtual driver (102) is a player in the virtual world. The simulated environment (204) is a simulation of a real-world environment, which may or may not be in actual existence, in which the autonomous system is designed to move. As such, the simulated environment (204) includes a simulation of the objects (i.e., simulated objects or agents) and background in the real world, including the natural objects, construction, buildings and roads, obstacles, as well as other autonomous and non-autonomous objects. The simulated environment simulates the environmental conditions within which the autonomous system may be deployed. The simulated objects may include both stationary and non-stationary objects. Non-stationary objects are agents in the real-world environment.

In the simulated environment, the geographic region is a realistic representation of a real-world region that may or may not be in actual existence. Namely, from the perspective of the virtual driver, the geographic region appears the same as if the geographic region were in existence if the geographic region does not actually exist, or the same as the actual geographic region present in the real world. The geographic region in the simulated environment includes virtual agents and virtual map elements that would be actual agents and actual map elements in the real world. Namely, the virtual agents and virtual map elements each have a physical location in the geographic region that denotes an exact spot or place in which the corresponding agent or map element is located. The map elements are stationary in the geographic region, whereas the agents may be stationary or nonstationary in the geographic region. As with the real-world, a map exists of the geographic region that specifies the physical locations of the map elements.

The simulator (200) includes an autonomous system model (216), sensor simulation models (214), and agent models (218). The autonomous system model (216) is a detailed model of the autonomous system in which the virtual driver (102) will execute. The autonomous system model (216) includes model, geometry, physical parameters (e.g., mass distribution, points of significance), engine parameters, sensor locations and type, firing pattern of the sensors, information about the hardware on which the virtual driver executes (e.g., processor power, amount of memory, and other hardware information), and other information about the autonomous system. The various parameters of the autonomous system model may be configurable by the user or another system.

The autonomous system model (216) includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. The interface between the virtual driver (102) and the simulator (200) may match the interface between the virtual driver (102) and the autonomous system in the real world. Thus, to the virtual driver (102), the simulator simulates the experience of the virtual driver within the autonomous system in the real world.

In one or more embodiments, the sensor simulation model (214) models, in the simulated environment, active and passive sensor inputs. The sensor simulation models (114) are configured to simulate the sensor observations of the surrounding scene in the simulated environment (204) at each time step according to the sensor configuration on the vehicle platform. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, and the measurements being simulated based on the simulated environment based on the simulated position of the sensor(s) within the simulated environment.

Agent models (218) represents an agent in a scenario. An agent is a sentient being that has an independent decision making process. Namely, in a real world, the agent may be an animate being (e.g., person or animal) that makes a decision based on an environment. The agent makes active movement rather than or in addition to passive movement. An agent model, or an instance of an actor model may exist for each agent in a scenario. The agent model is a model of the agent. If the agent is in a mode of transportation, then the agent model includes the model of transportation in which the agent is located. For example, actor models may represent pedestrians, children, vehicles being driven by drivers, pets, bicycles, and other types of actors.

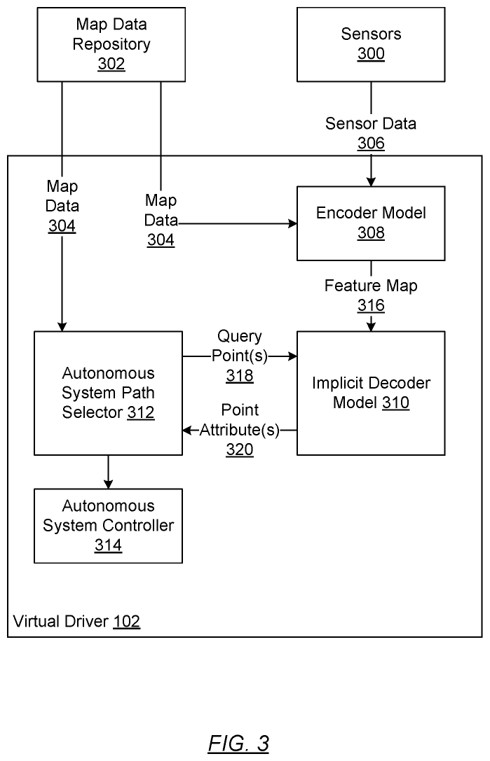

FIG. 3 shows a schematic diagram of the virtual driver (102) having an implicit occupancy system in accordance with one or more embodiments. As shown in FIG. 3, the virtual driver (102) is connected to a map data repository (302) and sensors (300). The map data repository (302) is a storage repository for map data (304). The map data (304) is a map of the geographic region with map elements, described above, located at their respective geographic locations in the map. For example, the map data may include the centerlines of lanes and roadways at their corresponding positions on a map.

The sensors (300) are virtual sensors (e.g., sensor simulation model (214) as described in FIG. 2) or physical sensors (e.g., sensors (104) described in FIG. 1). The sensors provide sensor data (306). Sensor data (306) may include LiDAR sweeps, LiDAR point clouds, camera images, or other types of sensor data. A LiDAR sweep provides a set of LiDAR points radiating outward from a LiDAR sensor. A LiDAR point cloud is a set of LiDAR points at corresponding locations.

Continuing with FIG. 3, the virtual driver (102) includes an encoder model (308), an implicit decoder model (310), an autonomous system path selector (312), and an autonomous system controller (314). Each of these components is described below.

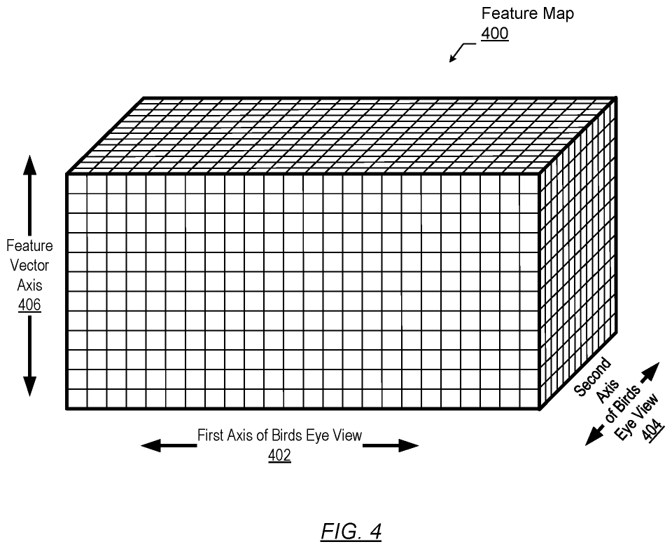

The encoder model (308) is a machine learning model configured to obtain sensor data (306) from the sensors (300), map data (304) from the map data repository (302), and generate a feature map (316) of the geographic region. The encoder model is a machine learning model or a collection of machine learning models that encodes the sensor data (306) and the map data (304) into the feature map (316). Specifically, the encoder model is designed to learn vector embeddings for the sensor data (306) and map data (304) that is used for prediction of point attributes at a variety of not yet specified times. A feature map (316) is a map of the geographic region with at least one axis having feature vectors for corresponding locations in the geographic region. The feature vectors are the vector embeddings. A feature map (316) is an encoding of the current and past states of the geographic region. In one or more embodiments, the feature map (316) does not include future occupancy information. An example of a feature map (316) is shown in FIG. 4.

Continuing with FIG. 3, an implicit decoder model (310) is a machine learning model configured to obtain a set of one or more query points (318) and output a set of one or more point attributes (320) for each of the query points (318). The implicit decoder model (310) is a neural network model that is configured to obtain and decode feature vectors from the feature map for a query point. A query point may include an identification of a geographic location and a time value. The time value is the future time for which the set of point attributes (320) is to be predicted. Further, the time may be specified relative to a current time. For example, the time value may be a few seconds in the future.

The point attributes (320) are attributes of the geographic location at the specified point in time. For example, the point attributes (320) may include the binary value of occupied or not occupied, a probability value of occupied or not occupied, a reverse flow vector specifying from where the object or agent occupying the geographic location came, an agent type identifier, an object type identifier or other attribute of the geographic point. An agent type identifier may be an identifier of the type of agent performing the occupancy without identifying the agent or trajectory of the agent itself. For autonomous systems that are vehicles, the agent type identifier may be pedestrian, truck, car, bicyclist, etc.

The autonomous system path selector (312) is configured to select a path for the autonomous system using map data (304). The autonomous system path selector (312) may use routing information, current sensor data (306), point attributes (320), and other inputs to select a path. The path includes trajectory and acceleration or speed. For example, the path may include slowing down in the same trajectory, turning, accelerating or decelerating, waiting, or performing another action.

The autonomous system controller (314) is a software process configured to send a control signal to an actuator of the autonomous system. The autonomous system controller (314) is configured to determine an action for the autonomous system to perform the path of the autonomous system path selector.

FIGS. 4-6 shows an example expanded form of various components of FIG. 3 in accordance with one or more embodiments. FIG. 4 shows a diagram of a three dimensional feature map (400) in accordance with one or more embodiments of the invention. The feature map of FIG. 4 may correspond to the feature map (316) shown in FIG. 3.

In the feature map (400) of FIG. 4, a first and second dimensions correspond to a birds eye view of the geographic region. A birds eye view may also be referred to as an aerial perspective view or a top down view of the geographic region. Specifically, a first axis of the feature map (400) is a first axis of the birds eye view (402), and the second axis of the feature map is a second axis of the birds eye view (404). For example, the first axis may correspond to East-West axis of the geographic region, and the second axis may correspond to a North-South axis of the geographic region. The first and second axes may correspond to different axes of the geographic region. As such, the plane formed by the first and second axis may match a road map or traffic map of the geographic region.

Further, the feature map is a multi-dimensional grid. A grid is a partitioning of a region into cells. In the three dimensional feature map of FIG. 4, two dimensions of the three dimensional grid that corresponds to the first and second axes partition the geographic region into discrete grid cells. Thus, each geographic location in the geographic region is within a particular grid cell. The third dimension corresponds to a third axis of the feature map that is a feature vector axis (406). The feature vector axis has an individual corresponding feature vector for each grid cell of the first and second axis. A one to one mapping may exist between the feature map and grid cells of the other dimensions. A feature vector is a vector of feature values. In one or more embodiments, the feature vector is a fixed size. Taken together, the feature map partitions the geographic region into sub-regions, whereby each subregion has a corresponding feature vector.

Although FIG. 4 shows a three dimensional feature map, a four dimensional feature map may be used. For example, if the autonomous system is an aircraft, three dimensions may be geographic locations in three dimensional space and the fourth dimension may be the feature vector.

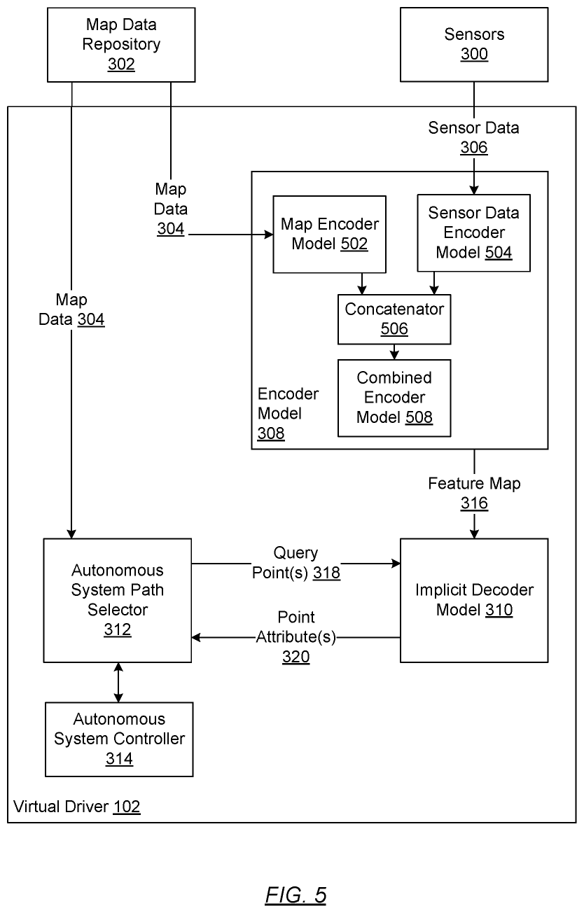

FIG. 5 shows a diagram of components of a virtual driver with an exploded view of the encoder model (308) in accordance with one or more embodiments of the invention. Components of FIG. 5 that have the same reference number as like-named components of FIG. 3 are the same as or similar to the like-named components.

As shown in FIG. 5, the encoder model (308) may be a particular combination of multiple models. The encoder model (308) may include a map encoder model (502), a sensor data encoder model (504), a concatenator (506), and a combined encoder model (508). The map encoder model (502) is a machine learning model that is configured to transform map data into map feature vectors for each sub-region of the geographic region. Specifically, as discussed above with reference to FIG. 4, the feature map partitions the geographic region into sub-regions, where each sub-region corresponds to a grid cell on two of the dimensions of the three dimensional grid of the feature map. The map encoder model (502) generates a map encoding of the map that is used for the map feature vectors. Thus, the output of the map encoder model (502) is a map feature map, such as similar to that which is described above with reference to FIG. 4, but with only map data features. An example of a map encoding model may be or may include a convolutional neural network.

The sensor data encoder model (504) is configured to encode sensor data (306). If the sensor data is LiDAR, the LiDAR data may be received as a list of LiDAR points. LiDAR points in the list may be voxelized in a three dimensional LiDAR grid, where each grid cell is for a geographic location. For each grid cell of the LiDAR grid, the value of the grid cell may be set to one if a LiDAR point exists in the list that identifies the grid cell or zero if no point exists. The result of the voxelizing is a binary three dimensional grid for the geographic region specifying where the LiDAR points are located. Multiple LiDAR sweeps may be combined or voxelized in the same LiDAR grid. In such a scenario, a grid cell of the LiDAR grid may be set to one if any of the LiDAR points in any of the LiDAR sweeps identifies the geographic location of the grid cell. Thus, if multiple LiDAR sweeps are combined, current or historical sweeps, then the LiDAR may also reflect an immediate preceding occupation of the three dimensional geographic region. Although binary values for the grid cells of the LiDAR grid are described, the values of the grid cells may be set based on the elapse time from when the LiDAR sweep was performed. Further, rather than a three dimensional LiDAR grid, a two dimensional LiDAR grid may be used whereby the third dimension is projected on the birds eye view.

The sensor data encoder model (504) may then generate a vector embedding of the LiDAR grid. The vector embedding is a sensor data feature vector for each grid cell of a birds eye view of the geographic region in one or more embodiments. Namely, the output of the sensor data encoder model (504) is a sensor data feature map, such as similar to the feature map described in reference to FIG. 4, but with only sensor data features. The sensor data encoder model (504) may be a convolutional neural network.

A concatenator (506) is configured to concatenate each map feature vector with the corresponding sensor data feature vector to generate a concatenated feature vector. Two feature vectors correspond when the two feature vectors are for the same sub-region of the geographic region. The concatenation feature vector may have a first portion of the map feature vector and a second portion of the sensor data feature vector. Stated another way, the map feature map and the sensor data feature map may have the same resolution in terms of the dimensions that correspond to the geographic region. The concatenator may overlay the map feature map on the sensor data feature map to generate a concatenated feature map. Thus, the concatenated feature vector has a latent description of the geometry (i.e., as specified in the map data) of the geographic region and the motion around the geographic region.

The combined encoder model (508) is an encoder model that combines the feature vectors of the map feature vectors and the sensor data feature vector. Specifically, the combined encoder model may generate a set of features that represent both map elements and sensor data. The combined encoder model may also include convolutional layers. The combined feature map may be the same or different resolution or size as the feature map generated by the combined encoder model (508).

Various techniques may be used to implement the various encoder models. For example, vision transformer models may be used. As another example, the encoder models may include convolutional neural network layers connected to one or more attention layers connected to additional convolutional neural network layers.

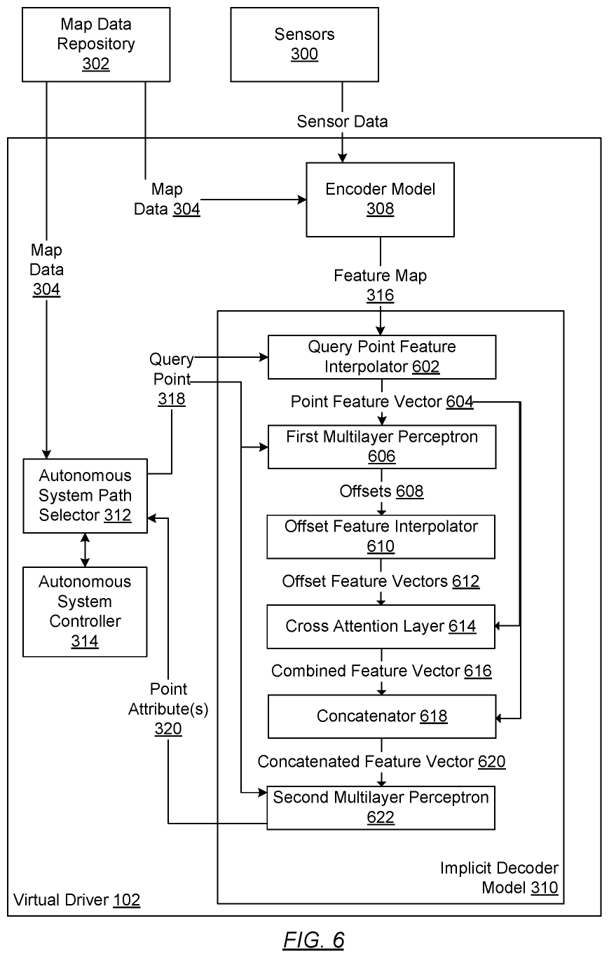

FIG. 6 shows a diagram of components of a virtual driver with an exploded view of the implicit decoder model (310) in accordance with one or more embodiments of the invention. Components of FIG. 6 that have the same number as corresponding components of FIG. 3 are the same or similar to the corresponding components.

In one or more embodiments, the implicit decoder model (310) is configured to process query points in parallel with each other. Thus, for the purposes of explanation, a single query point is shown. However, the implicit decoder model (310) may perform the same pipeline across several query points.

The implicit decoder model (310) includes a query point feature interpolator (602) that is configured to interpolate a point feature vector (604) from the feature map (316). The query point feature interpolator (602) takes the geographic location as input and interpolates a new feature vector (i.e., the point feature vector (604)) from the nearest feature vectors of the feature map to the geographic location. Thus, whereas the feature map may have a predefined resolution, denoted by the size of the sub-regions of the geographic region that correspond to each grid cell, the determination of point attribute may be on any resolution.

The first multilayer perceptrons (606) are a set of neural network layers that takes, as input, the query point (318) and the point feature vector (604) and generates, as output, offsets (608). An offset specifies a distance and direction from the query point (318). Each offset corresponds to an offset location in the geographic region, whereby an offset location is a physical location in the geographic region that is offset from the query point. In one or more embodiments, the number of offsets is predefined.

The offsets (608) are processed by an offset feature interpolator (610) to generate offset feature vectors (612). The offset feature interpolator (610) may perform the same function as the query point feature interpolator (602) but for offset locations instead of the geographic location in the query point (318). For example, the same block of code may be used for the offset feature interpolator (610) as for the query point feature interpolator (602). The output of the offset feature interpolator (610) are offset feature vectors (612).

A cross attention layer (614) obtains the offset feature vectors (612) and the point feature vector (604) and generates a combined feature vector (616). The combined feature vector has aggregated features that are aggregated from the offset feature vector (612) and the point feature vector (604).

A concatenator (618) is configured to concatenate the point feature vector (604) with the combined feature vector (616). For example, the concatenation may be to append the point feature vector (604) at the end of the combined feature vector (616). The concatenator (618) generates a concatenated feature vector (620).

The concatenated feature vector (620) is used as input with the query point (318) to second multilayer perceptrons (622) that generates a set of point attributes (320) as output. The second multilayer perceptrons (622) are neural network layers that may classify the geographic location in the query point as occupied or not, provide the reverse flow, and perform other classifications.

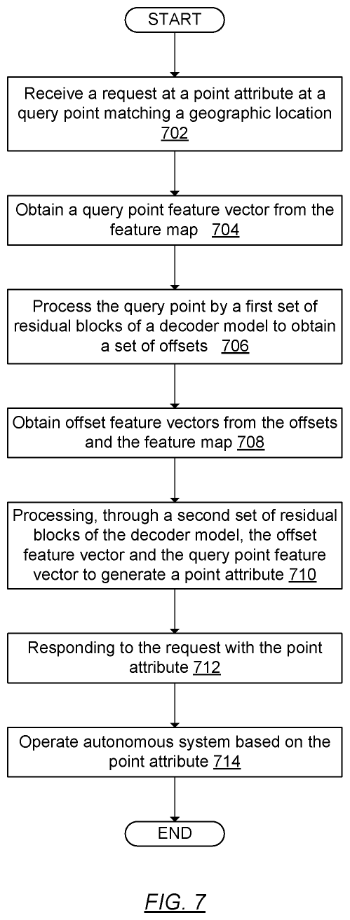

FIG. 7 shows a flowchart for performing implicit occupancy in accordance with one or more embodiments. In one or more embodiments, prior to performing the operations of FIG. 7, a feature map is generated. The feature map is used for a current set of query points. As the autonomous system moves through the environment, physical or virtual, new feature maps are generated to accommodate the movement of traffic through the region. Thus, the generation of feature maps is performed in real-time.

In one or more embodiments, LiDAR data is obtained as a set of LiDAR sweeps of the geographic region. Each of the LiDAR sweeps includes a set of LiDAR points. As the autonomous system moves through the environment the LiDAR sensors of the autonomous system perform LiDAR sweeps. In the virtual environment, the sensor simulation model simulates the LiDAR sweeps that would be generated based on the current state of the virtual environment. Thus, LiDAR sweeps data may be provided in both the simulated and virtual environment. Binary values of grid cells in a three dimensional LiDAR grid are set according to the positions of the grid cells being identified by a LiDAR point in the set of LiDAR points of at least one of the LiDAR sweeps in the set of LiDAR sweeps. The sensor data encoder model then executes on the LiDAR grid to encode the LiDAR grid in order to generate a sensor feature map. Although LiDAR sensor data is described as being used to generate the sensor feature map, camera images may be used. In such a scenario, the camera images may be passed through a machine learning model to generate a set of birds eye view camera feature maps of the region over time. The birds eye views may be passed through a sensor data encoding model to generate a sensor data feature map.

Similarly, a road map of the geographic region may be encoded through a map encoder model to generate a map encoding. The map encoding is a map feature map. In some embodiments, the map feature map may be pre-generated.

The map encoding and the sensor encoding are concatenated by concatenating the map feature grid with the sensor data feature grid to generate the combined feature encoding. The combined feature encoding is processed through a combined encoder model to generate the feature map.

The process of generating the feature map may be performed asynchronously with executing the implicit decoder model. In one or more embodiments, when a feature map is generated, the same feature map is used for providing point attributes responsive to the query point. Thus, for a particular query point, the same feature map is used for both the query point feature vector and the offset feature vectors.

In Block 702, a request for a point attribute at a query point matching a geographic location is received. In one or more embodiments, the implicit decoder receives a request with a set of query points. For example, the set of query points may be received from a different model of the virtual driver that attempts to select a trajectory for the autonomous system. The set of query points may be received as a list of query points. Each query point may include an identifier of the geographic location and a time for the geographic location. Namely, the time may be the time for which the point attribute is requested. The implicit decoder may process each query point individually and in parallel.

In Block 704, a query point feature vector is obtained from the feature map. In some embodiments, the query point feature vector may be obtained directly from the feature map. For example, the implicit decoder model may process query points at a same resolution as the feature map. In such a scenario, the location specified in the query point is used to lookup the position in the feature map corresponding to the sub-region having the location. The corresponding feature vector is returned as the query point feature vector.

In some embodiments, the query point feature vector is a combination of multiple feature vectors. The feature vectors in the feature map may be related to the centroids of the corresponding sub-region to which the feature vectors correspond. Thus, rather than being for the entire sub-region, the feature vector is related to a particular point in the sub-region. Here, related to means that the feature vector is mapped to or otherwise linked to the centroid of the sub-region (e.g., in a one to one mapping).

In the embodiments in which the query point feature vector is a combination of feature vectors, to obtain a query point feature vector, the following operations may be performed. From the entire set of feature vectors in the feature map, a set of feature vectors that are adjacent to the query point in the feature map is selected. Specifically, the set of feature vectors include the feature vectors that are related to the adjacent centroids of sub-regions, whereby the adjacent centroids are adjacent to the geographic location specified in the query point. For example, four, six, or nine feature vectors that are related to the four, six, or nine closest centroids may be selected.

The selected feature vectors are interpolated to obtain the query point feature vector. Bilinear interpolation is performed using the selected feature vectors to obtain the query point feature vector. Bilinear interpolation uses a weighted summation, whereby the weights are based on the relative position of the selected feature vector and the query point.

In Block 706, the query point feature vector is processed by a first set of multilayer perceptrons of a decoder model to obtain a set of offsets. The query point may be concatenated onto the query point feature vector and processed by the first set of multilayer perceptrons. The first set of multilayer perceptrons effectively learns, without identifying objects or actors, information about objects and actors that may cause the geographic location in the query point to be occupied at the future moment in time.

In Block 708, offset feature vectors are obtained from the offsets and the feature map. The offset feature vectors may be obtained in a same or similar technique to obtaining the query point feature vector. In one or more embodiments, the offsets are processed individually as follows. The offset is combined with the geographic location in the query point to obtain an offset point. The offset point is a geographic location that is the offset distance and direction from the geographic location in the query point. From the query point, the set of feature vectors is selected based on adjacency in the feature map of the set of feature vectors to the offset point specified by the offset. The set of feature vectors is interpolated using the relative position of the offset to the set of feature vectors to obtain an offset feature vector of the plurality of offset feature vectors. Selecting and interpolating the set of feature vectors is performed as described in Block 704. The result is a set of offset feature vectors.

In Block 710, the offset feature vectors and the query point feature vector are processed through a second set of multilayer perceptrons of the decoder model to generate a point attribute. The second set of multilayer perceptrons determines the point attributes for the query point.

In one or more embodiments, prior to processing the offset feature vectors and the query point feature vector through the multilayer perceptrons, preprocessing is performed. The preprocessing includes the offset feature vectors and the query point feature vector being first processed by a cross attention layer to generate an output vector. The cross attention layer combines the features of the offset feature vectors and the query point feature vector when generating the output vector, which may be processed by the multilayer perceptrons. Prior to processing the output vector by the multilayer perceptrons, further processing may be performed. The output vector may be concatenated with the query point feature vector to generate a concatenated vector. Thus, the concatenated vector includes both the output vector that is a combination of features for the offset points and the query point. Effectively, because the query point feature vector is concatenated with the output vector that is the combination, the query point feature vector has more focus in the concatenated vector. The second set of multilayer perceptrons then executes on the concatenated vector combined with the query point. Specifically, the neural network layers of the second set of multilayer perceptrons process the concatenated vector with the query point to generate the point attributes.

In Block 712, the decoder model responds to the request with the point attribute. The decoder model may provide a resulting set of point attributes for each query point in the set of query points. One of the point attributes may be the predicted occupancy of the geographic location at a time specified by the query point. Predicted occupancy may be performed by comparing a probability of occupancy with a threshold to generate a binary value. The decoder model may output the binary value or the probability. For probability, the output of the second set of multilayer perceptrons may be a value between negative infinity and infinity. The output may be passed through a sigmoid layer that changes the value to a value to a probability between zero and one. In some embodiments, multiple occupancy values are outputted. Each of the different occupancy values may correspond to a particular type of agent or object. For example, a vector of occupancy values may be outputted, where each position in the vector corresponds to one of pedestrian, bicycle, car, truck, inanimate object, or other type of traffic. When the predicted occupancy is that the geographic location is occupied at the time, the set of point attributes may further include a reverse flow value to the query point. Specifically, the second set of multilayer perceptrons may be further trained to predict the flow to the geographic location.

In Block 714, the autonomous system is operated based on the point attribute. The virtual driver may use the occupancies of the query points to determine a current trajectory of the autonomous system that satisfies safety criteria (e.g., avoiding collisions, having stopping distance, etc.) and other criteria (e.g., shortest path, reduced number of lane changes, etc.) and is in furtherance of the moving to the destination. Then, the virtual driver may output a control signal to one or more actuators. In the real-world environment, the control signal is used by an actuator that causes the autonomous system to perform an action, such as causing the autonomous system to move in a particular direction at a particular speed or acceleration, to wait, to display a turn signal, or to perform other action. In the simulated environment, the control signal is intercepted by a simulator that simulates the actuator and the resulting action of the autonomous system. The simulator simulates the autonomous system thereby training the virtual driver. Namely, the output of simulating the autonomous system in the simulated environment may be used to evaluate the actions of the virtual driver.

Training of the system may be performed as follows. A set of training data with agents and objects labeled may be used as input. The set of training data may include past movements of the object. Notably, instead of labeled actors and objects, point clouds to the objects may be used. If a query point lands on the object, the label for the query point is the reverse vector for the query. Thus, from the set of training data, training locations, corresponding times, and the reverse flow to the training locations are defined.

Specifically, one or more embodiments randomly sample a training query point in a geographic region of interest and in future time from the set of training data. The weights of the first set of multilayer perceptrons are initialized so that the offsets have a value close to zero. Thus, the initial set of offset points is close to the query point. Through training, the weights of the multilayer perceptrons are updated so that the offset points are more useful and may be increased. The number of offsets is a hyperparameter to the first set of multilayer perceptrons. The training sample and the training data is fed through the model. For occupancy, cross entropy loss is used. For reverse flow, the L1 loss is calculated when the sample training query point is occupied. After computing the cross entropy loss and the L1 loss, back propagation may be performed to update the weights throughout the system.

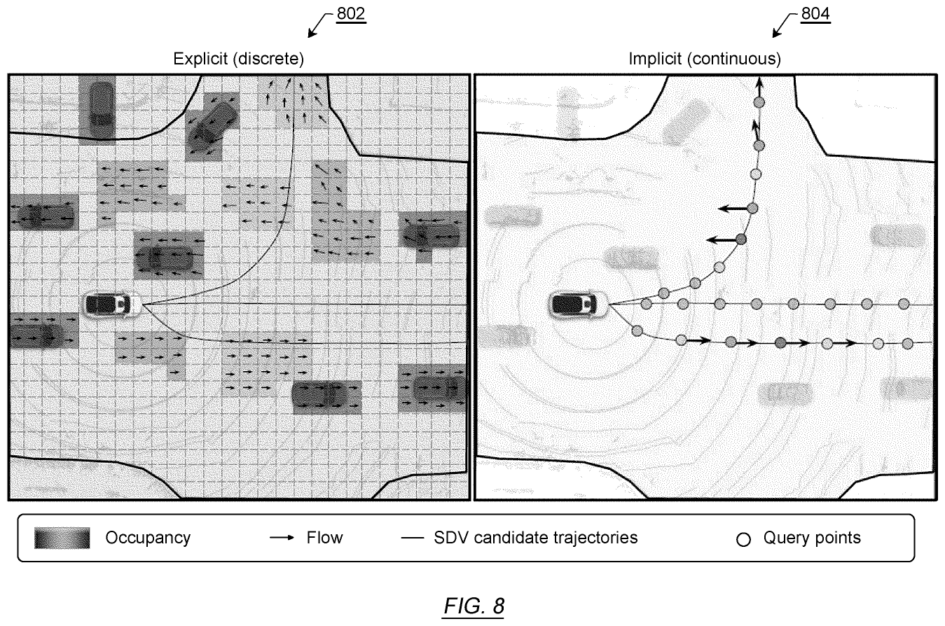

FIG. 8 shows an example diagram of a regional map showing a difference between generating occupancy values for an entire grid (left map (802)) versus generating implicit occupancy for a set of query points (right map (804)). The autonomous system is an autonomous vehicle shown at the center of the respective maps. As shown, in the left map (802), a fixed resolution grid is generated and occupancy values are outputted for each cell in the fixed resolution grid. To accommodate the time series nature of the trajectory autonomous vehicle, multiple such grids are generated for each moment in time. The times corresponding to each grid point is fixed as well. Thus, a large amount of unused data may be generated which has both fixed resolution in time and space.

As shown in the right map (804), implicit occupancy uses a set of query points along different trajectories (3 in the example). Each query point has a time at which the autonomous system is projected to be at the query point. The time intervals may be the same or different along the different trajectories. Further, the determination of whether the query point is occupied is not limited to a fixed resolution, but rather to the query point itself. Notably, the decoder may be further trained to output whether a specified distance around the query point is occupied. Thus, the question of occupancy may be for the query point and a threshold distance around the query point. The result is a set of values along the particular trajectories that indicate whether or not occupied and, if occupied, the reverse flow.

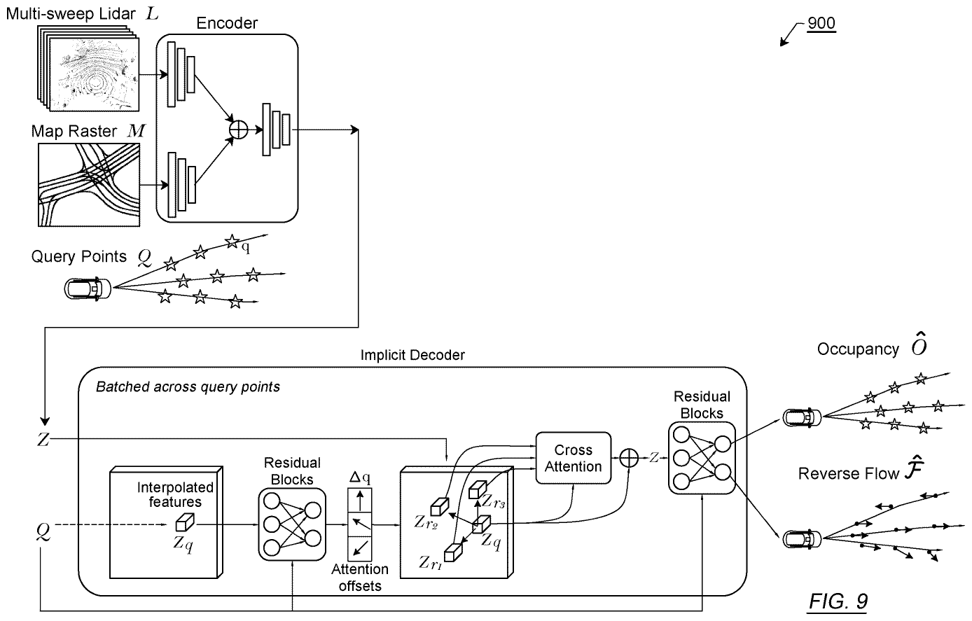

FIG. 9 shows an example implementation (900) of the encoder model and the decoder model of the virtual driver in accordance with one or more embodiments. The example is for explanatory purposes only and not intended to limit the scope of the invention. In the example of FIG. 9, the first and second multilayer perceptron is a set of residual blocks.

Input parameterization may be performed as follows. The model may take, as input, a voxelized LiDAR representation (L) as well as a raster of the high definition (HD) map (M). For the LiDAR, let Sₜ={s_{t−T}_{_{history}}₊₁, . . . , s_{t} be the sequence of the most recent T}_{history}=5 sweeps. More precisely, s_{t′}∈^{P}^{_{t′}}^{×3} is the LiDAR sweep ending at timestep t′ containing a set of P_{t′} points, each of which is described by three features: (pₓ, p_{y}, pₕ). pₓ and p_{y} are the location of the point relative to the self driving vehicle (SDV)'s reference frame at the current timestep t. The reference frame is centered at the SDV's current position and with the x-axis pointing along the direction of its heading. pₕ corresponds to the height of the point above the ground. Finally, L=Voxelize(Sₜ)∈R^{T}^{_{history}}^{D×H×W}, where the multi-sweep birds eye view (BEV) voxelization is performed with a discretization of D depth channels normal to the BEV plane, H height pixels and W width pixels. For the raster map, One or more embodiments take the lane centerlines C represented as polylines from the high-definition map and rasterize them on a single channel M=Raster(C)∈R^{1×H×W} with the same spatial dimensions.

The output parameterization is as follows. Let q=(x, y, t)∈R³ be a spatio-temporal point in BEV, at a future time t. The task is to predict the probability of occupancy o:R³→[0,1], and the flow vector f:R³→² specifying the BEV motion of any agent that occupies that location. One or more embodiments model the backwards flow for the flow vector f, as the backwards flow can capture multi-modal forward motions with a single reverse flow vector per grid cell. More concretely, backwards flow describes the motion at time t and location (x, y) as the translation vector at that location from t−1 to t, should there be an object occupying the location as shown in Eq. 1:

$$f ( x , y , t ) = {( {x}^{′} , {y}^{′} )}_{t - 1} - {( x , y )}_{t} , \qquad ( Eq . 1 )$$

where (x′, y′) denotes the BEV location at time t−1 of the point occupying (x, y) at time t.

Thus, the network architecture in the example implementation is shown in FIG. 9. One or more embodiments parameterize the predicted occupancy ô and flow \hat{f} with a multi-head neural network ψ. This network takes as input the voxelized LiDAR L, raster map M, and a mini-batch Q containing |Q| spatio-temporal query points q, and estimates the occupancy Ô={ô(q)}_{q∈Q} and flow \hat{F}={\hat{f}(q)}_{q∈Q} for the mini-batch in parallel as shown in Eq. 2:

$$\hat{O} , \hat{F} = ψ ( L , M , Q ) \qquad ( Eq . 2 )$$

The network ψ is divided into a convolutional encoder that computes scene features, and an implicit decoder that outputs the occupancy-flow estimates, as shown in FIG. 9.

The encoder in the implementation may include two convolutional stems that process the BEV LiDAR and map raster, a residual network (ResNet) that takes the concatenation of the LiDAR and map raster features and outputs multi-resolution feature planes, and a lightweight Feature Pyramid Network (FPN) that processes the feature planes. This results in a BEV feature map at half the resolution of the inputs, i.e.,

$$Z {∈}^{C \times \frac{H}{2} \times \frac{W}{2}} .$$

The feature map contains contextual features capturing the geometry, semantics, and motion of the scene. Notably, every spatial location (feature vector) in the feature map Z contains spatial information about its neighborhood (i.e., the size of the receptive field of the encoder), as well as temporal information over the past T_{history} seconds. In other words, each feature vector in Z may contain important cues regarding the motion, the local road geometry, and neighboring agents.

One or more embodiments design an implicit occupancy and flow decoder that are motivated by the intuition that the occupancy at query point q=(x, y, t)∈Q might be caused by a distant object moving at a fast speed prior to time t. Thus, one or more embodiments would like to use the local features around the spatio-temporal query location to suggest where to look next. For instance, there might be more expressive features about an object around its original position (at times {(t−T_{history}+1), . . . , t}) since that is where the LiDAR evidence is. Neighboring traffic participants that might interact with the object occupying the query point at time t are also relevant to look for (e.g., lead vehicle, another vehicle arriving at a merging point at a similar time).

To implement these intuitions, one or more embodiments first bi-linearly interpolate the feature map Z at the query BEV location q_{x,y}=(x, y) to obtain the feature vector z_{q}=Interp(Z, x, y)∈^{C} that contains local information around the query. One or more embodiments then predict K reference points {r₁, . . . , r_{K}} by offsetting the initial query point rₖ=q+Δqₖ, where the offsets Δq are computed by employing the fully connected ResNet-based architecture proposed by Convolutional Occupancy Networks. For each offset, one or more embodiments then obtain the corresponding features zᵣ_{ₖ}=Interp(Z, rₖ). This can be seen as a form of deformable convolution; a layer that predicts and adds 2D offsets to the regular grid sampling locations of a convolution, and bi-linearly interpolates for feature vectors at those offset locations. To aggregate the information from the deformed sample locations, one or more embodiments use cross attention between learned linear projections of z_{q}∈R^{1×C} and Zᵣ={zᵣ_{₁}, . . . , zᵣ_{ₖ}}∈R^{K×C}. The result is the aggregated feature vector z. Finally, z and z_{q} are concatenated, which, along with q, is processed by another fully connected ResNet-based architecture with two linear layer heads to predict occupancy logits and flow.

Training may be performed as follows. One or more embodiments train the implicit network by minimizing a linear combination of an occupancy loss and a flow loss as shown in Eq. 3:

$$L = {L}_{o} + {λ}_{f} {L}_{f} . \qquad ( Eq . 3 )$$

Occupancy is supervised with binary cross entropy loss H between the predicted and the ground truth occupancy at each query point q∈Q,

$${L}_{o} = \frac{1}{\vert Q \vert} {\sum }_{q ∈ Q} H ( o ( q ) , \hat{o} ( q ) ) , \qquad ( Eq . 4 )$$

In Eq. 4, o(q) and ô(q) are ground truth and predicted occupancy and query point q, respectively. The ground truth labels are generated by directly calculating whether or not the query point lies within one of the bounding boxes in the scene. One or more embodiments supervised the flow only for query points that belong to the foreground, i.e., points that are occupied. By doing so, the model learns to predict the motion of a query location should the query location be occupied. One or more embodiments use the l₂ error, where the labels are backwards flow targets from t to t−1 computed as rigid transformations between consecutive object box annotations as shown in Eq. 5:

$${L}_{f} = \frac{1}{\vert Q \vert} {\sum }_{q ∈ Q} o ( q ) \vert \vert f ( q ) - \hat{f} ( q ) {\vert \vert}_{2} . \qquad ( Eq . 5 )$$

One or more embodiments train with a batch of continuous query points Q, as opposed to points on a regular grid as previously proposed. More concretely, for each example, one or more embodiments sample |Q| query points uniformly across the spatio-temporal volume [0, H]×[0, W]×[0, T], where H∈R and W∈R are the height and width of a rectangular region of interest (RoI) in BEV surrounding the SDV, and T∈R is the future horizon being forecasted.

Thus, as shown, the system is trained to predict the occupancy and the flow for particular query points. One or more embodiments may provide a unified approach to joint perception and prediction for self-driving that implicitly represents occupancy and flow over time with a neural network. This queryable implicit representation can provide information to a downstream motion planner more effectively and efficiently. The implicit architecture predicts occupancy and flow more accurately than contemporary explicit approaches in both urban and highway settings.

As discussed above, the implicit occupancy does not identify agents or physical objects in the geographic region to predict whether a geographic location will be occupied. However, agents or objects may be identified for other purposes without departing from the scope of the invention.

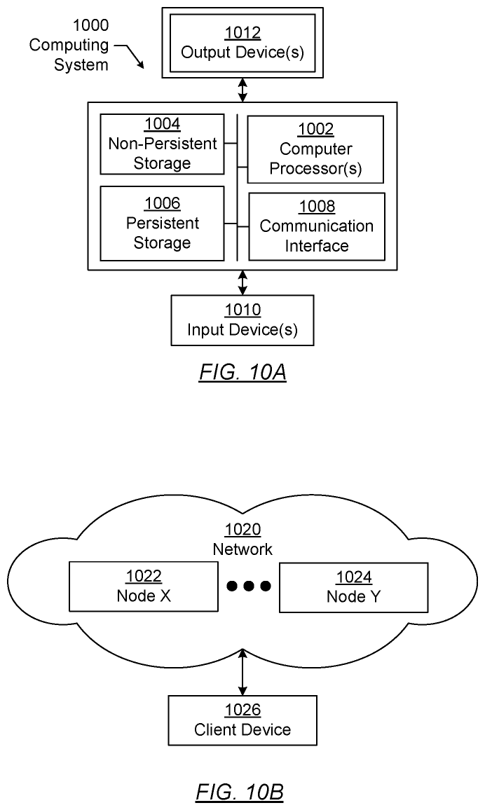

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 10A, the computing system (1000) may include one or more computer processors (1002), non-persistent storage (1004), persistent storage (1006), a communication interface (1008) (e.g., Bluetooth interface, infrared interface, network interface, optical interface, etc.), and numerous other elements and functionalities that implement the features and elements of the disclosure. The computer processor(s) (1002) may be an integrated circuit for processing instructions. The computer processor(s) may be one or more cores or micro-cores of a processor. The computer processor(s) (1002) includes one or more processors. The one or more processors may include a central processing unit (CPU), a graphics processing unit (GPU), a tensor processing unit (TPU), combinations thereof, etc.

The input devices (1010) may include a touchscreen, keyboard, mouse, microphone, touchpad, electronic pen, or any other type of input device. The input devices (1010) may receive inputs from a user that are responsive to data and messages presented by the output devices (1012). The inputs may include text input, audio input, video input, etc., which may be processed and transmitted by the computing system (1000) in accordance with the disclosure. The communication interface (1008) may include an integrated circuit for connecting the computing system (1000) to a network (not shown) (e.g., a local area network (LAN), a wide area network (WAN) such as the Internet, mobile network, or any other type of network) and/or to another device, such as another computing device.

Further, the output devices (1012) may include a display device, a printer, external storage, or any other output device. One or more of the output devices may be the same or different from the input device(s). The input and output device(s) may be locally or remotely connected to the computer processor(s) (1002). Many different types of computing systems exist, and the aforementioned input and output device(s) may take other forms. The output devices (1012) may display data and messages that are transmitted and received by the computing system (1000). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (1000) in FIG. 10A may be connected to or be a part of a network. For example, as shown in FIG. 10B, the network (1020) may include multiple nodes (e.g., node X (1022), node Y (1024)). Each node may correspond to a computing system, such as the computing system shown in FIG. 10A, or a group of nodes combined may correspond to the computing system shown in FIG. 10A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1000) may be located at a remote location and connected to the other elements over a network.

The nodes (e.g., node X (1022), node Y (1024)) in the network (1020) may be configured to provide services for a client device (1026), including receiving requests and transmitting responses to the client device (1026). For example, the nodes may be part of a cloud computing system. The client device (1026) may be a computing system, such as the computing system shown in FIG. 10A. Further, the client device (1026) may include and/or perform all or a portion of one or more embodiments.

The computing system of FIG. 10A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a request for a point attribute at a query point matching a geographic location;
obtaining a query point feature vector from a feature map, the feature map encoding a geographic region comprising the geographic location;
processing, by a first set of multilayer perceptrons of a decoder model, the query point feature vector to generate a plurality of offsets;
obtaining, from the feature map, a plurality of offset feature vectors for the plurality of offsets;
processing, by a second set of multilayer perceptrons of the decoder model, the plurality of offset feature vectors, and the query point feature vector to generate the point attribute; and
responding to the request with the point attribute.

2. The method of claim 1, wherein obtaining the query point feature vector comprises:
selecting, from a plurality of feature vectors of the feature map, a first set of feature vectors that are adjacent to the query point in the feature map; and
performing bilinear interpolation using the first set of feature vectors to obtain the query point feature vector.

3. The method of claim 2, wherein interpolating the first set of feature vectors uses a weight for each feature vector of the first set of feature vectors that is dependent on a relative position of the feature vector to the query point in the feature map.

4. The method of claim 2, wherein obtaining the plurality of offset feature vectors comprises:
for an offset of the plurality of offsets:
selecting, from the feature map, a second set of feature vectors based on adjacency in the feature map of the second set of feature vectors to an offset point specified by the offset, and
performing bilinear interpolation using the second set of feature vectors to obtain an offset feature vector of the plurality of offset feature vectors.

5. The method of claim 1, wherein the feature map comprises:
a first axis and a second axis comprising a birds eye view of the geographic region, and
a third axis comprising a set of features generated by encoding LiDAR data and map data of the geographic region.

6. The method of claim 5, further comprising:
obtaining the LiDAR data as a set of LiDAR sweeps of the geographic region, each of the set of LiDAR sweeps comprising a set of LiDAR points;
setting binary values of grid cells in a three dimensional grid according to positions of the grid cells being identified by a LiDAR point in the set of LiDAR points of at least one of the LiDAR sweeps in the set of LiDAR sweeps; and
encoding, by a sensor data encoder model, the three dimensional grid.

7. The method of claim 6, wherein the sensor data encoder model comprises a convolutional neural network.

8. The method of claim 1, further comprising:
encoding, by a sensor data encoder model, sensor data to obtain an encoded sensor data.

9. The method of claim 8, further comprising:
encoding a map of the geographic region through a map encoder model to generate a map encoding; and
concatenating the map encoding with the encoded sensor data to generate a combined feature encoding.

10. The method of claim 9, further comprising:
processing the combined feature encoding through a combined encoder model to generate the feature map.

11. The method of claim 1, wherein the point attribute is a predicted occupancy of the geographic location at a time specified by the query point.

12. The method of claim 1, wherein the point attribute further comprises a reverse flow value to the query point.

13. The method of claim 1, wherein the query point comprises an identifier of the geographic location and a time for the geographic location.

14. The method of claim 1, further comprising:
processing, by a cross attention layer, the plurality of offset feature vectors and the query point feature vector to generate an output vector,
wherein processing, by the second set of multilayer perceptrons of the decoder model, the plurality of offset feature vectors and the query point feature vector is performed by processing the output vector.

15. The method of claim 1, further comprising:
processing, by a cross attention layer, the plurality of offset feature vectors and the query point feature vector to generate an output vector; and
concatenating the output vector with the query point feature vector to generate a concatenated vector,
wherein processing, by the second set of multilayer perceptrons of the decoder model, the plurality of offset feature vectors and the query point feature vector is performed by processing the concatenated vector.

16. A system comprising:
a computer processor; and
non-transitory computer readable medium for causing the computer processor to perform operations comprising:
receiving a request for a point attribute at a query point matching a geographic location;
obtaining a query point feature vector from a feature map, the feature map encoding a geographic region comprising the geographic location;
processing, by a first set of multilayer perceptrons of a decoder model, the query point feature vector to generate a plurality of offsets;
obtaining, from the feature map, a plurality of offset feature vectors for the plurality of offsets;
processing, by a second set of multilayer perceptrons of the decoder model, the plurality of offset feature vectors, and the query point feature vector to generate the point attribute; and
responding to the request with the point attribute.

17. The system of claim 16, wherein the feature map comprises:
a first axis and a second axis comprising a birds eye view of the geographic region, and
a third axis comprising a set of features generated by encoding LiDAR data and map data of the geographic region.

18. The system of claim 16, wherein the operations further comprises:
processing, by a cross attention layer, the plurality of offset feature vectors and the query point feature vector to generate an output vector; and
concatenating the output vector with the query point feature vector to generate a concatenated vector,
wherein processing, by the second set of multilayer perceptrons of the decoder model, the plurality of offset feature vectors and the query point feature vector is performed by processing the concatenated vector.

19. A non-transitory computer readable medium comprising computer readable program code for causing a computer system to perform operations comprising:
receiving a request for a point attribute at a query point matching a geographic location;
obtaining a query point feature vector from a feature map, the feature map encoding a geographic region comprising the geographic location;
processing, by a first set of multilayer perceptrons of a decoder model, the query point feature vector to generate a plurality of offsets;
obtaining, from the feature map, a plurality of offset feature vectors for the plurality of offsets;
processing, by a second set of multilayer perceptrons of the decoder model, the plurality of offset feature vectors, and the query point feature vector to generate the point attribute; and
responding to the request with the point attribute.

20. The non-transitory computer readable medium of claim 19, wherein the operations further comprises:
processing, by a cross attention layer, the plurality of offset feature vectors and the query point feature vector to generate an output vector; and
concatenating the output vector with the query point feature vector to generate a concatenated vector,
wherein processing, by the second set of multilayer perceptrons of the decoder model, the plurality of offset feature vectors and the query point feature vector is performed by processing the concatenated vector.
